(19) United States
(12) Patent Application Publication
(10) Pub. No.: US 2007/0090972 A1
(43) Pub. Date: Apr. 26, 2007

(54) Airborne digital video recorder

(76) Inventors: David A. Monroe, San Antonio, TX (US); Jeffrey D. Browning, Boerne, TX (US)

Correspondence Address: Attn: Kirt S. O'Neill;AKIN, GUMP, STRAUSS, HAUER & FELD, L.L.P., P.O. Box 12870, San Antonio, TX, 78212, US

(21) Appl. No.: 11/451,007

(22) Filed: Jun. 12, 2006

Related U.S. Application Data
(60) Provisional application No. 60/689,487, filed on Jun. 10, 2005.

(51) Int. Cl. G08B 21/00

(52) U.S. Cl. 340/945

(57) ABSTRACT

An airborne digital video system comprising a first video router adapted to receive at least one aircraft data, at least one analog to digital converter adapted to receive a routed aircraft data form the first video router and at least one digital video recorder coupled to the analog to digital converter adapted to play digital aircraft data received from the analog to digital converter.

### CROSS-REFERENCE TO RELATED APPLICATIONS

The present invention claims priority from U.S. provisional patent application serial No. 60/689,487, filed on Jun. 10, 2000, titled AIRBORNE DIGITAL VIDEO RECORDER, the entire contents of which are incorporated by reference herein. The present invention is further related to patent application Ser. No. 09/593,901, filed on Jun. 14, 2000, titled DUAL MODE CAMERA, patent application Ser. No. 09/593,361, filed on Jun. 14, 2000, titled DIGITAL SECURITY MULTIMEDIA SENSOR, patent application Ser. No. 09/594,041, filed on Jun. 14, 2000, titled MULTIMEDIA SURVEILLANCE AND MONITORING SYSTEM INCLUDING NETWORK CONFIGURATION, patent application Ser. No. 09/716,141, filed on Nov. 17, 2000, titled METHOD AND APPARATUS FOR DISTRIBUTING DIGITIZED STREAMING VIDEO OVER A NETWORK, patent application Ser. No. 09/715,783, filed on Nov. 17, 2000, titled MULTIPLE VIDEO DISPLAY CONFIGURATIONS AND BANDWIDTH CONSERVATION SCHEME FOR TRANSMITTING VIDEO OVER A NETWORK, from pending patent application Ser. No. 09/725,368, filed on Nov. 29, 2000, titled MULTIPLE VIDEO DISPLAY CONFIGURATIONS AND BANDWIDTH CONSERVATION SCHEME FOR TRANSMITTING VIDEO OVER A NETWORK, patent application Ser. No. 09/854,033, filed on May 11, 2001, titled PORTABLE, WIRELESS MONITORING AND CONTROL STATION FOR USE IN CONNECTION WITH A MULTI-MEDIA SURVEILLANCE SYSTEM HAVING ENHANCED NOTIFICATION FUNCTIONS, patent application Ser. No. 09/853,274 filed on May 11, 2001, titled METHOD AND APPARATUS FOR COLLECTING, SENDING, ARCHIVING AND RETRIEVING MOTION VIDEO AND STILL IMAGES AND NOTIFICATION OF DETECTED EVENTS, patent application Ser. No. 09/960,126 filed on Sep. 21, 2001, titled METHOD AND APPARATUS FOR INTERCONNECTIVITY BETWEEN LEGACY SECURITY SYSTEMS AND NETWORKED MULTIMEDIA SECURITY SURVEILLANCE SYSTEM, patent application Ser. No. 09/966,130 filed on Sep. 21, 2001, titled MULTIMEDIA NETWORK APPLIANCES FOR SECURITY AND SURVEILLANCE APPLICATIONS, patent application Ser. No. 09/974,337 filed on Oct. 10, 2001, titled NETWORKED PERSONAL SECURITY SYSTEM, patent application Ser. No. 10/134,413 filed on Apr. 29, 2002, titled METHOD FOR ACCESSING AND CONTROLLING A REMOTE CAMERA IN A NETWORKED SYSTEM WITH A MULTIPLE USER SUPPORT CAPABILITY AND INTEGRATION TO OTHER SENSOR SYSTEMS, patent application Ser. No. 10/163,679 filed on Jun. 5, 2002, titled EMERGENCY TELEPHONE WITH INTEGRATED SURVEILLANCE SYSTEM CONNECTIVITY, patent application Ser. No. 10/266,813 filed on Oct. 8, 2002, titled ENHANCED APPARATUS AND METHOD FOR COLLECTING DISTRIBUTING, AND ARCHIVING HIGH RESOLUTION IMAGES, patent application Ser. No. 10/719,792 filed on Nov. 21, 2003, titled METHOD FOR INCORPORATING FACIAL RECOGNITION TECHNOLOGY IN A MULTIMEDIA SURVEILLANCE SYSTEM RECOGNITION APPLICATION, patent application Ser. No. 10/753,658 filed on Jan. 8, 2004, titled MULTIMEDIA COLLECTION DEVICE FOR A HOST WITH SINGLE AVAILABLE INPUT PORT, patent application Ser. No. 60/624,598 filed on Nov. 3, 2004, titled COVERT NETWORKED SECURITY CAMERA, patent application Ser. No. 09/143,232 filed on Aug. 28, 1998, titled MULTIFUNCTIONAL REMOTE CONTROL SYSTEM FOR AUDIO AND VIDEO RECORDING, CAPTURE, TRANSMISSION, AND PLAYBACK OF FULL MOTION AND STILL IMAGES, patent application Ser. No. 09/687,713 filed on Oct. 13, 2000, titled APPARATUS AND METHOD OF COLLECTING AND DISTRIBUTING EVENT DATA TO STRATEGIC SECURITY PERSONNEL AND RESPONSE VEHICLES, patent application Ser. No. 10/295,494 filed on Nov. 15, 2002, titled APPARATUS AND METHOD OF COLLECTING AND DISTRIBUTING EVENT DATA TO STRATEGIC SECURITY PERSONNEL AND RESPONSE VEHICLES, patent application Ser. No. 10/192,870 filed on Jul. 10, 2002, titled COMPREHENSIVE MULTI-MEDIA SURVEILLANCE AND RESPONSE SYSTEM FOR AIRCRAFT, OPERATIONS CENTERS, AIRPORTS AND OTHER COMMERCIAL TRANSPORTS, CENTERS, AND TERMINALS, patent application Ser. No. 10/719,796 filed on Nov. 21, 2003, titled RECORD AND PLAYBACK SYSTEM FOR AIRCRAFT, patent application Ser. No. 10/336,470 filed on Jan. 3, 2003, titled APPARATUS FOR CAPTURING, CONVERTING AND TRANSMITTING A VISUAL IMAGE SIGNAL VIA A DIGITAL TRANSMISSION SYSTEM, patent application Ser. No. 10/326,503 filed on Dec. 20, 2002, titled METHOD AND APPARATUS FOR IMAGE CAPTURE, COMPRESSION AND TRANSMISSION OF A VISUAL IMAGE OVER TELEPHONIC OR RADIO TRANSMISSION SYSTEM, patent application Ser. No. 10/776,129 filed on Feb. 11, 2004, titled SYSTEM FOR A PLURALITY OF VIDEO CAMERAS DISPOSED ON A COMMON NETWORK and from pending patent application Ser. No. 10/971,857, filed on Oct. 22, 2004, titled MULTIPLE VIDEO DISPLAY CONFIGURATIONS AND REMOTE CONTROL OF MULTIPLE VIDEO SIGNALS TRANSMITTED TO A MONITORING STATION OVER A NETWORK, patent application Ser. No. 11/057,645 filed on Feb. 14, 2005, titled MULTIFUNCTIONAL REMOTE CONTROL SYSTEM FOR AUDIO AND VIDEO RECORDING, CAPTURE, TRANSMISSION AND PLAYBACK OF FULL MOTION AND STILL IMAGES, patent application Ser. No. 11/057,814, filed on Feb. 14, 2005, titled DIGITAL SECURITY MULTIMEDIA SENSOR, and patent application Ser. No. 11/057,264, filed on Feb. 14, 2005, titled NETWORKED PERSONAL SECURITY SYSTEM, patent application Ser. No. 11,111,575, filed on Apr. 21, 2005, titled BANDWIDTH MANAGEMENT AND CONTROL, the contents of each of which are incorporated by reference herein.

The present invention describes an airborne image transceiver and recorder which can be supplied in several configurations, depending, for example, on the mission requirements of the particular airborne platform. As illustrated in FIG. 1, the system consists of:

A digital video device, typically located in an aircraft equipment bay and not accessible by the pilot. This module contains:
A video input multiplexer 101 that selects one of several video inputs.
A video output multiplexer 102, capable of routing video to several places
A video analog-to-digital (A/D) converter 103
A video digital-to-analog (D/A) converter 104
A processor 105, to process the digitized video, control the tape storage mechanism, and handle other system ‘housekeeping’ chores.

An optional scan-rate converter (not shown) is often integrated into the system. This allows inter-operation between various video sources and display devices with different scan rates and video formats.

A control unit 106 for use by aircrew. This device currently takes the form of a simple day/night text display and a series of user pushbuttons.

A video recording and playback device 107. To date, recording, storage and playback of video has been accomplished using tape-transport recording systems.

The product is integrated with the platform sensors as follows:

A variety of aircraft imagery sensors are connected to the input video router 101 of the system. These sensors may be daylight cameras, infrared cameras (such as FLIR's for usage at night or in poor visibility), or other image/video collection devices. These devices may operate with a variety of different video formats including NTSC, PAL, and other formats.

A variety of aircraft display devices are likewise connected to it via video output router 102. As before, the video displays may use conventional composite video formats such as NTSC or PAL, or may use other video formats.

One of the aircraft's radios 108 is connected to the device. This allows transmission of stored imagery to ground or air stations as required. It likewise provides a means to receive images from other stations, for display within the aircraft. The radio communications pathway is typically encrypted, either by external devices 109 and 112, or by an encryption device residing within the radio.

As described, storage and retrieval of the video imagery has historically been accomplished using tape media, such as Video Tape Recorder 107 in FIG. 1. This approach has been necessitated by the wide bandwidth typical of analog video signals. Advances in technology, however, now permit the usage of a solid-state, “no-moving-parts” storage approach. In this approach, incoming sensor video is digitized, compressed, and stored in a solid-state memory, or alternatively in a large-capacity disk drive. The present invention describes such an approach.

Digital video storage is not new—a number of consumer products exist which digitize a video signal, compress it, and store it in some form of digital memory. For example, a consumer-grade product exists which digitizes, records, and plays back a video signal, allowing consumers to view selected television programs at a time of their convenience. Commonplace digital cameras capture imagery, digitize it, compress it, and store it to flash memory. Also, a number of video security/surveillance systems are available which capture video from a number of cameras, digitize, compress, and store the video. These Digital Video Recorders (DVRs) are enjoying widespread acceptance in the marketplace. The present invention replaces a tape-based recording subsystem of a Video Tape Recorder (VTR—item 107 in FIG. 1) with a DVR unit. In the present invention, the pre-existing RS-422 control channel and associated VTR firmware is modified as necessary to control the record and playback functions of the DVR.

### BRIEF DESCRIPTION OF THE SEVERAL VIEWS OF THE DRAWINGS

The foregoing summary, as well as the following detailed description of preferred embodiment of the invention, will be better understood when read in conjunction with the appended drawings. For the purpose of illustrating the invention, there is shown in the drawings, an embodiment which is presently preferred. It should be understood, however, that the invention is not limited to the precise arrangements and instrumentalities shown.

In the drawings:

FIG. 1 is a block diagram of an airborne digital video recording system employing a tape recorder.

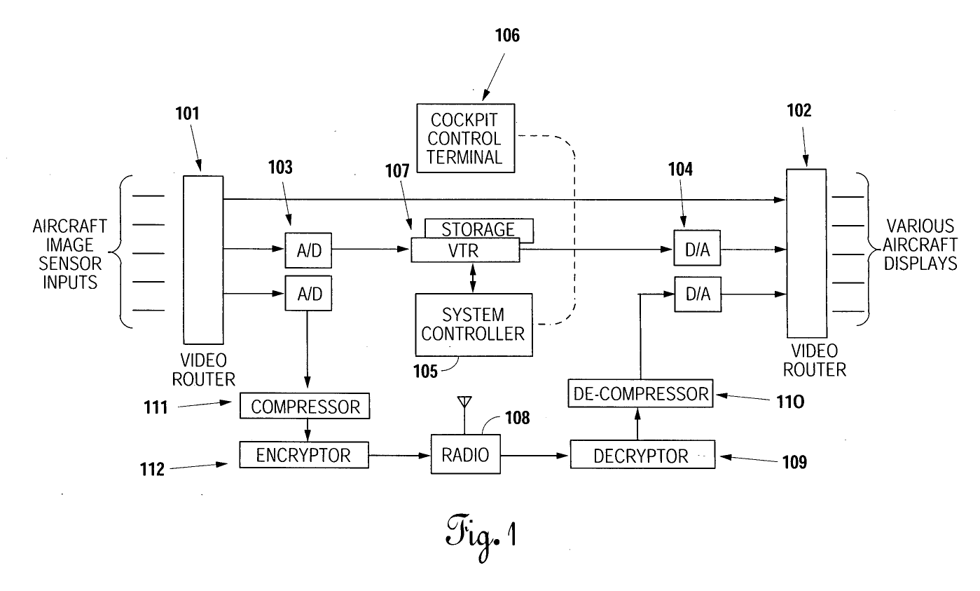

FIG. 2 is a block diagram of an airborne digital video recording system employing multiple video recorders.

FIG. 3 is a block diagram of an airborne DVR system including a system controller to manage the storage and play back of video, audio, and other aircraft data.

FIG. 4 is a block diagram of an airborne DVR system having scan rate conversation capability.

FIG. 5 is a block diagram of an airborne DVR system integrated with an aircraft data and control bus.

FIG. 6 is a block diagram of an airborne DVR system adapted to be controlled by a remote aircraft or ground station.

FIG. 7 is a block diagram of an airborne DVR system having network connectivity or ground station for off-board video uploading and downloading.

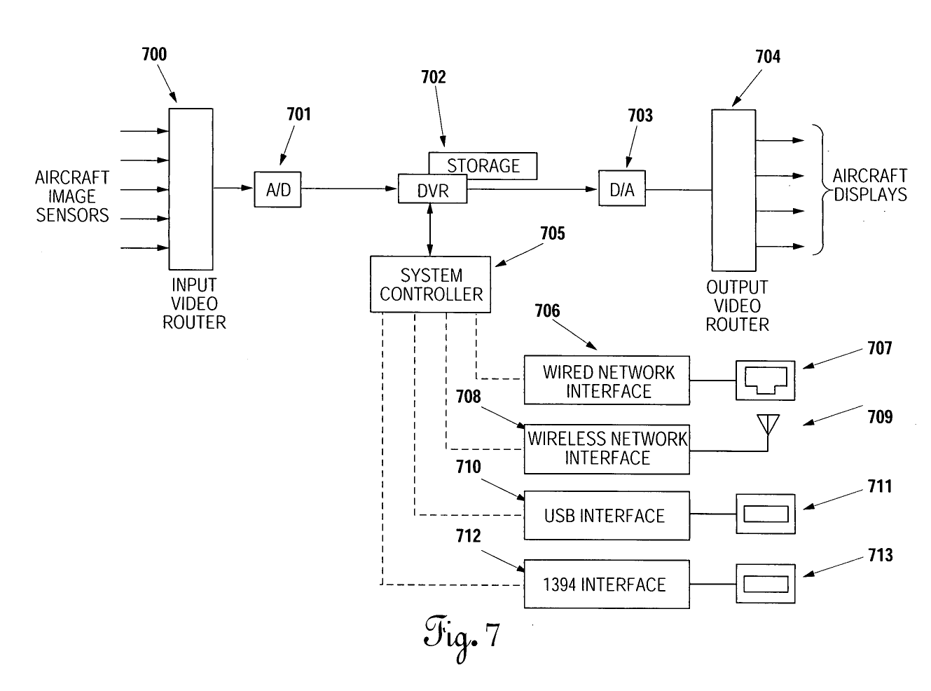

FIG. 8 is a block diagram of a ground network and command center in communication with an airborne DVR system of the present invention.

FIG. 9 is a block diagram of an airborne DVR system augmented with a video processor for processing aircraft video and other imagery.

A number of additional functions to the present invention include:

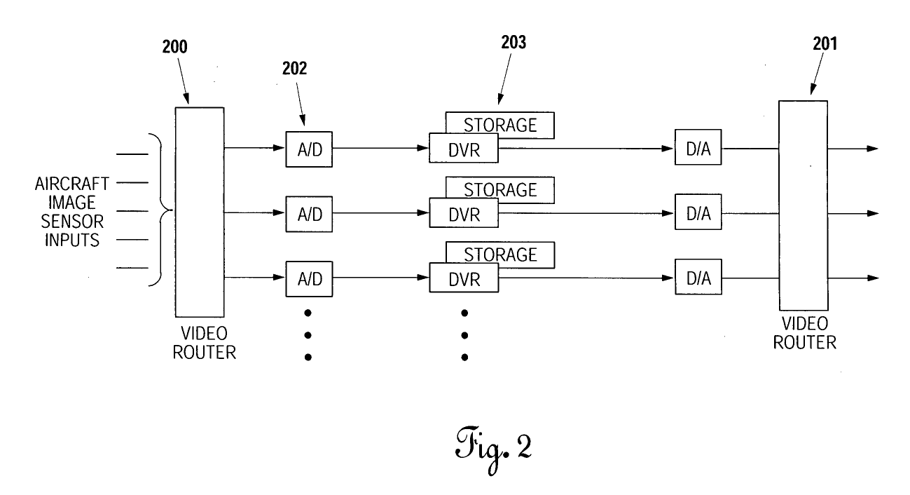

As depicted in FIG. 2, additional A/D converters 202 and DVR units 203 may be added to the system, to allow simultaneous recording or playback of more than one video stream.

Other types of aircraft data can be stored. For example, post-mission analysis may be enhanced if data from the aircraft MIL-1553 bus or ACMI data is recorded by the system, and temporally correlated with the stored visual data.

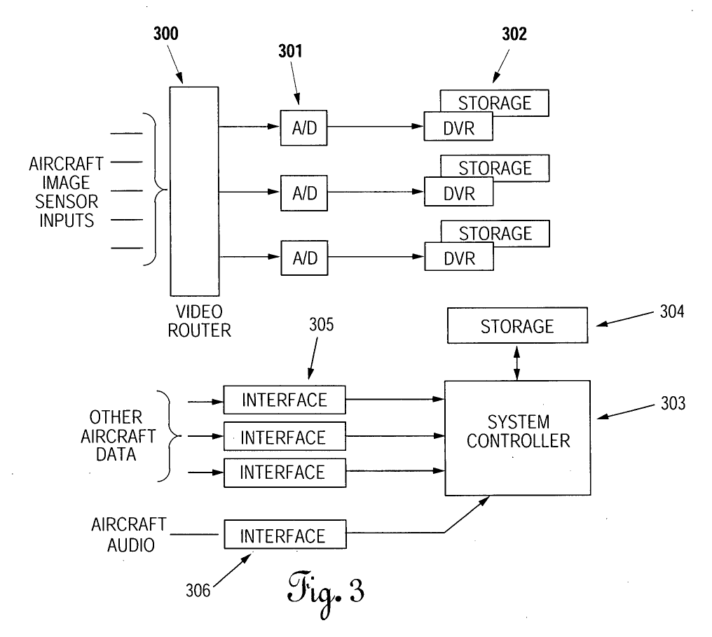

In FIG. 3, several video streams from aircraft sensors are simultaneously digitized and recorded via video router 300, A/D converters 201, and DVR's 302. In addition, data from other aircraft systems are connected to the system via interfaces 305, and data therefrom is recorded in storage medium 304 under control of the system controller 303. System controller 303 is responsible for time stamping the incoming data as required to support subsequent time-correlated playback of said data in conjunction with recorded video, if required. In addition, aircraft interphone or radio audio may be connected to the system via audio interface 306, and subsequently compressed and recorded via system controller 303 and storage medium 304. Again, the system controller is responsible for time-stamping the recorded audio, to support subsequent correlated playback with recorded video or other aircraft data.

A scan-rate converter can be used and operated in an environment containing many different types and formats of video signals.

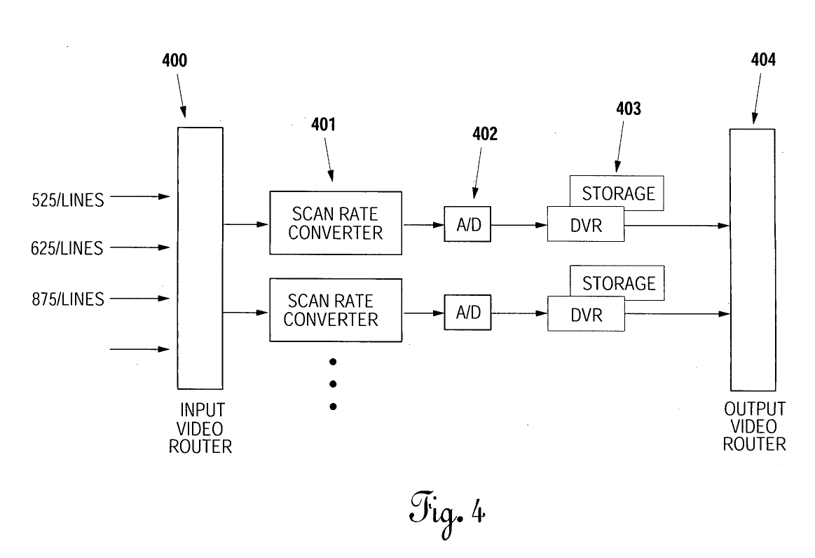

In FIG. 4, for example, the video input router 400 receives a 525-line video signal (perhaps NTSC), a 625-line video signal (perhaps PAL), and an 875-line high-resolution video signal from a FLIR sensor. Scan-rate converters 401 accept these incoming video signals, and down-sample the video signals so as to produce a 525-line output signal. Alternatively, lower-resolution video input signals may be converted up to a higher resolution, to achieve compatibility with the display devices used by the aircraft. Typically, though, video signals are converted to either 525 line or 625 line formats, to retain compatibility with DVR's 403.

A user can control the VTR functions via a small terminal in the cockpit. As previously described, this product contains a small text display and six user pushbuttons for control of the system. If required, the present invention will allow other aircraft systems to control the system record, playback, and transmit/receive functions.

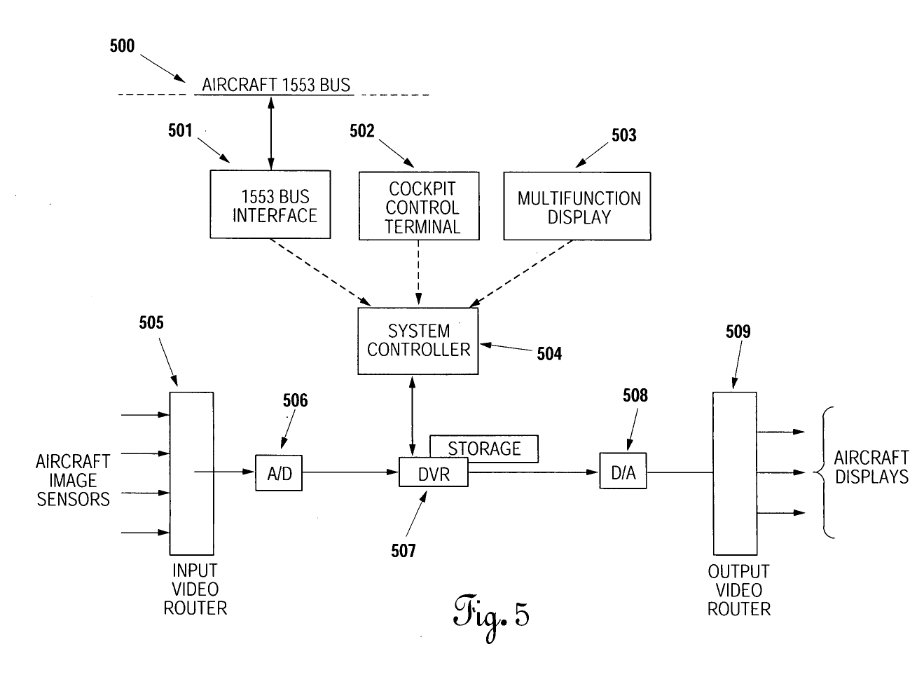

In FIG. 5, the core system previously described (comprising input router 505, A/D converter 506, DVR 507, system controller 504, D/A 508, and output router 509) are controlled by the cockpit control terminal 502. In an enhancement of the product, however, the core system may be controlled by a Multi-Function display device 503, or by other aircraft systems using the aircraft MIL-1553 bus 500 and 1553 bus interface 501. In addition to simply supporting remote control of the core system, note that the aircraft data bus may also be used to convey compressed image data to and from the core system, including incoming video and images, or recorded video and images. Typically, such video and/or imagery must be compressed in order to stay within the capacity limitations of the aircraft data bus.

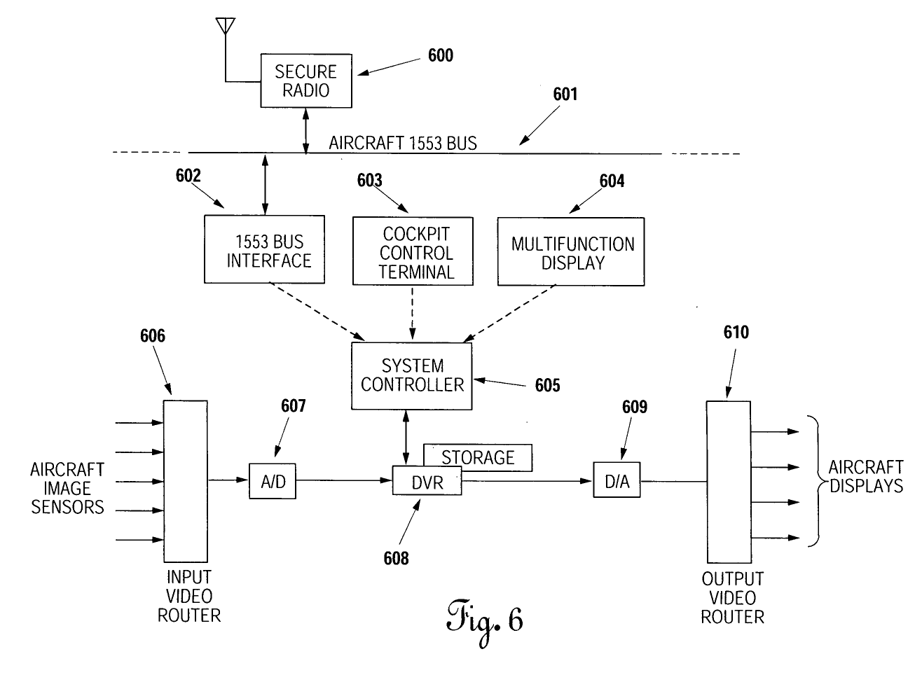

In FIG. 6, the system has been enhanced to allow a remote aircraft or ground station to effect control of the core system, via the (presumably secure) aircraft radio 600, the aircraft data bus 601, and bus interface 602. This arrangement allows remote control of storage, playback, transmission and other system controls to be accomplished by other aircraft or ground stations. This may be useful, for example, in controlling storage/playback/transmission of a system on an unmanned aircraft, either from another aircraft or from a ground-based control center.

Video and other imagery captured by the aircraft may be downloaded electronically if desired. This may be done by providing a wired 10/100 Ethernet connection 706, wireless Ethernet connection 708, USB connection 710, IEEE 1394 (Firewire) interface 712, and so forth, to the product. Captured imagery may thereby be downloaded and shared using commonplace networking techniques.

Certain emerging computer network topologies now support wireless networking of aircraft in-flight. This may be used to upload images to the aircraft, receive or download images or video from the aircraft, or to share other information useful to the mission.

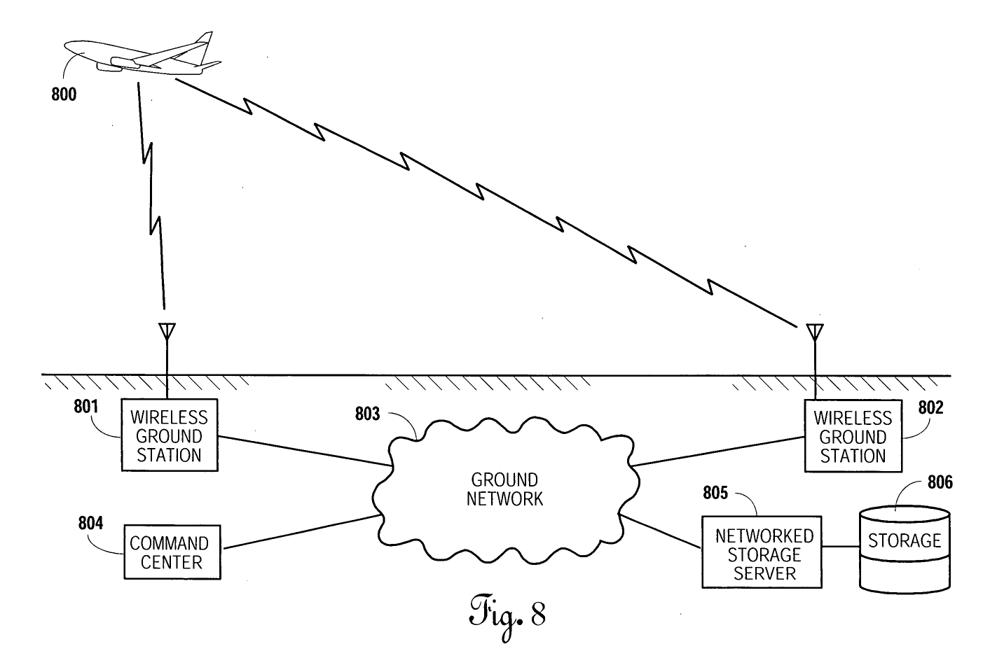

In FIG. 8, an aircraft in flight 800 is in communication with one or more ground stations 801 and 802. Data received from aircraft 800 at the ground stations may thereby be conveyed via network 803 to command center 804 and storage server 805. Data thus received may include video, images, audio, aircraft sensor data, flight data, and so forth.

In-flight wireless computer networks make it possible to stream real-time video from the aircraft, and to share said video with any number of users via commonplace networks.

Thus networked, it is possible to combine data from other aircraft systems with the live or captured images or video. For example, captured imagery may be overlaid with graphical information from a moving-map server, also located on the aircraft. The moving-map graphics may in fact be three-dimensional.

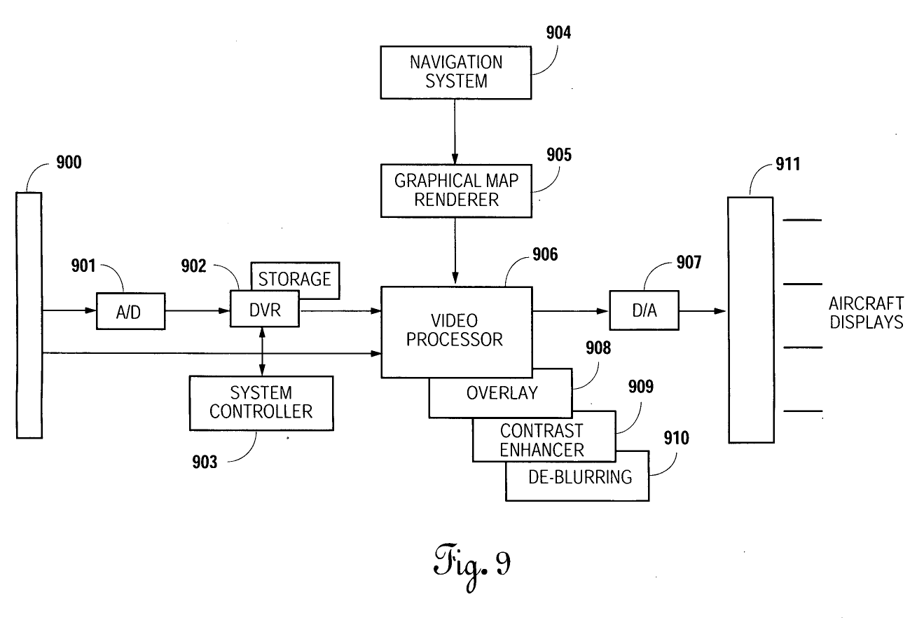

In FIG. 9, video retrieved from the system's DVR 902 is fed to video processor 906. Navigational data from the aircraft navigation systems (such as GPS or inertial navigational systems) is presented to an onboard map renderer_905, which produces a moving-map video signal. Video processor 906 subsequently overlays said moving map data on the video received from the on-board camera or DVR.

Networked devices aboard the aircraft permit sophisticated image processing, which may be useful in tactical situations. For example, in FIG. 9, a real-time image enhancer 909, such as produced by Digital Vision, enhances image contrast to improve detection and recognition of ground targets or other visual items of interest. Likewise, a de-blurring processor or algorithm 910 may be used to reduce the effects of atmospheric blurring on the image.

Although an exemplary embodiment of the system and method of the present invention has been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims. For example, the capabilities of the system can be performed by one or more of the modules or components described herein or in a distributed architecture. For example, all or part of the system, or the functionality associated with the system may be included within or co-located within the router or the DVR. Further, the functionality described herein may be performed at various times and in relation to various events, internal or external to the modules or components. Also, the information sent between various modules can be sent between the modules via at least one of a data network, the Internet, a voice network, an Internet Protocol network, a wireless source, a wired source and/or via plurality of protocols. Still further, more components than depicted or described can be utilized by the present invention.

What is claimed is:

1. An airborne digital video system, comprising:
a first video router adapted to receive at least one aircraft data;
at least one analog to digital converter adapted to receive a routed aircraft data form the first video router; and
at least one digital video recorder coupled to the analog to digital converter adapted to play digital aircraft data received from the analog to digital converter.

2. The system of claim 1 comprising at least one sensor adapted to produce the at least one aircraft data.

3. The system of claim 1, wherein the aircraft data is at least one of:
an interior aircraft image;
an exterior aircraft image;
a combination of an interior aircraft image and an exterior aircraft image;
an interior aircraft video;
an exterior aircraft video; and
a combination of an interior aircraft video and an exterior aircraft video.

4. The system of claim 3, wherein the at least one sensor is positioned in at least one of a following location:
in an interior of the aircraft;
in an exterior of the aircraft;
in a combination of an interior of the aircraft and an exterior of the aircraft.

5. The system of claim 1 comprising memory coupled to the at least one digital video recorder, wherein the memory is adapted to perform at least one of a following action:
store the digital aircraft data; and
permit an access of the digital aircraft data.

6. The system of claim 1 comprising a transceiver coupled to the analog to digital converter, wherein the transceiver is adapted to transmit capture images to at least one of a following location:
a module on an aircraft;
a module on another aircraft; and
a module on the ground.

7. The system of claim 6, wherein the module is at least one of:
a computer;
a phone; and
an electronic device capable of receiving and transmitting signals.

8. The system of claim 5 comprising a second video router coupled to the digital video recorder.

9. The system of claim 6, wherein the second video router is adapted to receive the digital aircraft data from at least one of:
the memory; and
the digital video recorder.

10. The system of claim 9, wherein the second video router is adapted to send the digital aircraft data to at least one of:
a display terminal in an aircraft; and
an electronic device in the aircraft.

11. The system of claim 10, wherein the electronic device is at least one of:
mounted in the aircraft;
adapted to be attached to an individual in the aircraft;
adapted to be attached to an individual near the aircraft;
adapted to be utilized by an individual in the aircraft; and
adapted to be utilized by an individual near the aircraft.

12. A digital video system, comprising:
a video router adapted to receive at least one data;
at least one analog to digital converter adapted to receive a routed data form the first video router; and
at least one digital video recorder coupled to the analog to digital converter adapted to play data received from the analog to digital converter.

13. The digital video system of claim 12 comprising a system controller coupled to the digital video recorder.

14. The digital video system of claim 13 comprising a cockpit control terminal coupled to the system controller.

15. The digital video system of claim 13 comprising a digital to analog converter coupled to the digital video recorder and a video router adapted to output at least one data.

16. The digital video system of claim 15, wherein the cockpit control terminal controls the receiving video router, the analog to digital converter, the digital video recorder, the digital to analog converter, and the output video router.

17. The digital video system of claim 15 comprising a multi-function display device coupled to the system controller, wherein the multi-function display device controls the receiving video router, the analog to digital converter, the digital video recorder, the digital to analog converter, and the output video router.

18. The digital video system of claim 15 comprising a 1553 bus interface coupled to the system controller, wherein the multi-function display device controls the receiving video router, the analog to digital converter, the digital video recorder, the digital to analog converter, and the output video router.

19. A method for providing digital video data, comprising:
receiving data at an input video router from aircraft image sensors;
converting the received data at an analog to digital converter;
performing at least one of a following action to the digital data at a digital video recorder:
playing the digital data;
storing the digital data; and
controlling the digital data;
wherein the performing is provided by at least one of:
a cockpit control terminal;
a multi-function display device; and
a 1553 bus interface;
converting the performed action at a digital to analog converter;
receiving the converted data at an output video router; and
outputting the converted data to an aircraft display.

20. The method of claim 19, comprising controlling the input video router, the analog to digital converter, the digital video recorder, the digital to analog converter, and the output video router via an aircraft radio coupled to an aircraft data bus coupled to a bus interface coupled to a system controller coupled to the digital video recorder, wherein the controlling allows remote control of storage, playback, transmission and other system controls by other aircraft or by ground stations.
